(19) United States
(12) Patent Application Publication
(10) Pub. No.: US 2026/0029993 A1
(43) Pub. Date: Jan. 29, 2026

(54) SYSTEMS AND METHODS FOR ARTIFICIAL INTELLIGENCE TOOL FOR SOFTWARE CODE DEVELOPMENT THAT ESTIMATES RUNTIME PROCESSING EFFICIENCY OF SERVERLESS APPLICATIONS

(71) Applicant: Capital One Services, LLC, McLean, VA (US)

(72) Inventors: Sruthi RUDRAVAJJALA, Arlington, VA (US); Anne MOSHYEDI, Washington, DC (US); Michael WANG, Gaithersburg, MD (US)

(73) Assignee: Capital One Services, LLC, McLean, VA (US)

(21) Appl. No.: 18/785,582

(22) Filed: Jul. 26, 2024

(51) Int. Cl. G06F 8/33; G06F 11/36; G06F 40/205

(52) U.S. Cl. CPC G06F 8/33; G06F 11/3636; G06F 40/205

(57) ABSTRACT

Systems and methods for uses and/or improvements to artificial intelligence applications, particularly in the realm of code development. As one example, systems are described herein for an artificial intelligence tool for software code development that estimates runtime processing efficiency of serverless applications as well as provide recommendations for more efficient code for the serverless applications.

### BACKGROUND

Software review is challenging due to the complexity and variability inherent in software development. Unlike tangible products, software involves intricate codebases that can be difficult to understand and evaluate, especially if the reviewer is not familiar with the specific technologies or domain. The dynamic nature of software, with constant updates and iterations, adds another layer of difficulty, as the code can change rapidly, rendering previous reviews obsolete. Additionally, software functionality often depends on various external factors such as hardware, operating systems, and other integrated systems, making it hard to isolate and test in a controlled environment. Furthermore, the subjective nature of software quality, where aspects like user experience, performance, and maintainability come into play, complicates the review process. These elements require a deep understanding of not only the technical specifications but also the end-user needs and business goals, making software review a multifaceted and demanding task.

To further complicate software and code development, code development is increasingly being pushed to serverless computing services provided by cloud platforms, which allows developers to run code without provisioning or managing servers. While the use of serverless computing services allows developers to focus on writing and deploying individual functions that perform specific tasks instead of setting up and maintaining an entire server infrastructure, it also means processing efficiency code development, including timing spent writing code, testing code, etc. as well as the various iterations, is attributed a processing efficiency beyond the developers' time. Thus, there is increased pressure to accelerate this development.

One potential solution is the use of artificial intelligence, including, but not limited to, machine learning, deep learning, etc. (referred to collectively herein as artificial intelligence models, machine learning models, or simply models). Broadly described, artificial intelligence refers to a wide-ranging branch of computer science concerned with building smart machines capable of performing tasks that typically require human intelligence. Key benefits of artificial intelligence are its ability to process data, find underlying patterns, and/or perform real-time determinations. However, despite these benefits and despite the wide-ranging number of potential applications, practical implementations of artificial intelligence have been hindered by several technical problems. First, artificial intelligence may rely on large amounts of high-quality data. The process for obtaining this data and ensuring it is high-quality can be complex and time-consuming. Additionally, data that is obtained may need to be categorized and labeled accurately, which can be difficult, time-consuming and a manual task. Second, despite the mainstream popularity of artificial intelligence, practical implementations of artificial intelligence may require specialized knowledge to design, program, and integrate artificial intelligence-based solutions, which can limit the amount of people and resources available to create these practical implementations. Finally, results based on artificial intelligence can be difficult to review as the process by which the results are made may be unknown or obscured. This obscurity can create hurdles for identifying errors in the results, as well as improving the models providing the results. These technical problems may present an inherent problem with attempting to use an artificial intelligence-based solution for software review.

### SUMMARY

Systems and methods are described herein for novel uses and/or improvements to artificial intelligence applications, particularly in the realm of code development. As one example, systems are described herein for an artificial intelligence tool for software code development that estimates runtime processing efficiency of serverless applications as well as provide recommendations for more efficient code for the serverless applications.

Adapting artificial intelligence models for this practical benefit faces several technical challenges because writing code involves a deep understanding of the problem domain, user requirements, and/or specific context in which the code will be used. Moreover, the code must be robust, handle edge cases, and/or be easy to debug, which requires a comprehensive understanding of potential pitfalls and how to address them. Finally, any model that is used needs to understand and implement algorithms, data structures, and/or control flows, ensuring that the generated code is efficient and correct. Because of these technical challenges, any model that is trained must be specific to the objective, style, and/or developers looking to use the model; however, developers may often switch organizations, borrow code for other applications, make project-specific alterations, etc. Thus, there is no corpus of data available upon which to train a model.

The systems and methods overcome the lack of training data by generating training data using a novel approach. For example, while counterintuitive, the systems and methods may limit the amount and type of data used to generate training data to the user's existing code (e.g., available at a given serverless computing service provided by cloud platforms). As mentioned above, limiting training data is conventionally seen as detrimental as it leads to reduced accuracy, overfitting, and/or insufficient coverage of edge cases. However, limiting training data in this manner does ensure that the code is trained to the objective, style, and/or developers standards; thus, overcoming some of the technical challenges above.

With respect to the novel technical problem of reduced accuracy, overfitting, and/or insufficient coverage of edge cases, the model is trained to provide recommendations for more efficient lambda functions as opposed to the generic code itself. For example, lambda functions are typically smaller and more concise than generic code. They usually consist of a single expression or a few lines of code, making them easier to analyze and understand. This simplicity reduces the complexity the model needs to handle during training. Additionally, lambda functions have a consistent and well-defined structure. They follow a specific syntax, which makes it easier for models to recognize patterns and learn from them. This uniformity contrasts with the broader variability found in generic code. Finally, lambda functions are designed to perform specific, often single-purpose tasks. They encapsulate simple operations or transformations, making it easier for models to learn these specific tasks. Generic code, on the other hand, can encompass a wide range of functionalities and complexities, making it harder for models to generalize.

Furthermore, as opposed to training data for specific syntax structures, errors, and/or redundancies, the system trains a model to recommend lambda functions that reduce runtime processing efficiencies. For example, reducing runtime processing efficiencies is a clear, quantifiable objective. It can be measured directly in terms of execution time or computational resources consumed. This provides a straightforward metric for evaluating the performance of the model's recommendations. In contrast, identifying and correcting specific syntax structures, errors, and redundancies involves more subjective and nuanced assessments (thus requiring more training data). Additionally, the feedback loop for runtime processing efficiencies is immediate and objective. After making a change, the system can directly measure the impact on performance. This clear feedback loop helps in efficiently training and refining the model. Addressing syntax issues, errors, and redundancies often requires understanding code semantics and the broader context, making the feedback loop less direct (thus also requiring more training data). Finally, performance optimizations often focus on specific, isolated sections of code. They require understanding how individual functions or operations contribute to overall runtime. In contrast, fixing syntax errors, removing redundancies, or addressing semantic issues often requires a deep understanding of the entire codebase, its dependencies, and its logic flow (thus once again requiring mode training data).

In some aspects, systems and methods for software code development that estimates runtime processing efficiency of serverless applications to provide recommendations for more efficient code for the serverless applications are described. For example, the system may retrieve a first artificial intelligence model, wherein the first artificial intelligence model is trained to generate outputs of recommendations for alternative lambda functions in response to receiving inputs of code samples. The first artificial intelligence model may be trained by retrieving a first code base of a first user, parsing the first code base to determine a first set of lambda functions, determining respective runtime processing efficiencies for the first set of lambda functions, and generating training data by labeling the first set of lambda functions with the respective runtime processing efficiencies. The system may receive a first code sample for a first serverless application. The system may identify a first lambda function in the first code sample. The system may generate a first feature input for the first artificial intelligence model based on the first code sample and the first lambda function. The system may input the first feature input into the first artificial intelligence model to generate a first output. The system may generate for display, on a user interface, first recommendation comprising a second lambda function for replacing the first lambda function in the first code sample.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram for code featuring a lambda function, in accordance with one or more embodiments.

FIG. 2 shows an illustrative diagram for recommended code featuring a revised lambda function with an improved runtime efficiency, in accordance with one or more embodiments.

FIG. 3 shows illustrative components for a system used to estimate runtime processing efficiency of serverless applications and/or provide recommendations for more efficient code for the serverless applications, in accordance with one or more embodiments.

FIG. 4 shows a flowchart of the steps involved in providing recommendations for more efficient code, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

Systems and methods are described herein for novel uses and/or improvements to artificial intelligence applications, particularly in the realm of code development. As one example, systems are described herein for an artificial intelligence tool for software code development that estimates runtime processing efficiency of serverless applications as well as provide recommendations for more efficient code for the serverless applications.

As described herein, code development, also known as software development, is the process of designing, writing, testing, and/or maintaining the source code of computer programs. It encompasses a wide range of activities that involve understanding user requirements, creating algorithms, and implementing them in a programming language to solve specific problems or automate tasks. This process often begins with planning and designing the software architecture, followed by actual coding where developers write the code that will execute the planned functionalities. Testing ensures that the code works as intended and is free of bugs. Additionally, maintenance is essential to adapt the software to changing requirements, fix any issues that arise, and improve performance. Code development requires a combination of technical skills, creativity, problem-solving abilities, and often collaboration among team members to create efficient, reliable, and user-friendly software solutions.

As described herein, runtime processing efficiency may refer to the effectiveness with which a computer program, code, and/or algorithm executes its tasks, using the least amount of computational resources such as time and memory. It is a critical aspect of software performance, determining how quickly and smoothly a program can run, especially under varying loads. This efficiency is typically measured using metrics like execution time, which gauges how long it takes for a program to complete a task, and memory usage, which assesses the amount of RAM required during execution. Other relevant metrics can include CPU utilization, disk I/O operations, and network bandwidth consumption, depending on the nature of the application. Profiling tools and performance benchmarks are often employed to collect these metrics, providing insights into potential bottlenecks and areas for optimization. Efficient runtime processing not only enhances the user experience by making software faster and more responsive but also reduces operational costs, particularly in environments where resource consumption directly translates to monetary expenses, such as cloud computing.

In some embodiments, the system may determine the runtime processing efficiency of lambda functions in code samples. Code samples in code development are snippets or segments of source code that demonstrate how to accomplish specific tasks or implement particular functionalities within a programming environment. In code development, a lambda function (often referred to as a lambda or anonymous function) is a small, unnamed function defined with a concise syntax. It is typically used to create simple functions without the need for formally defining a full function using a name. Lambdas are commonly found in programming languages like Python, Java, C#, and JavaScript.

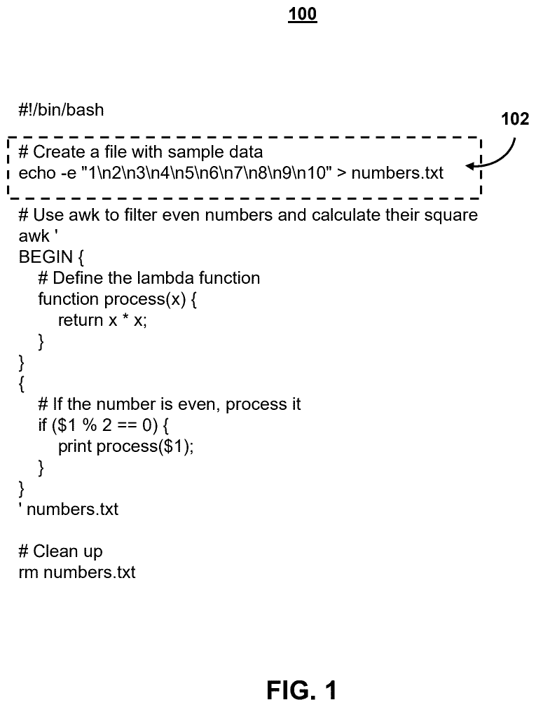

FIG. 1 shows an illustrative diagram for code featuring a lambda function, in accordance with one or more embodiments. For example, pseudocode 100 illustrates a lambda function in a shell script using ‘awk’, a text processing tool used in Unix-like operating systems. In this example, the lambda function filters and processes a list of numbers. Pseudocode 100 includes lambda function 102. Lambda function 102 includes a script that creates a file named numbers.txt with numbers from 1 to 10.

The awk command processes the file. The BEGIN block defines a lambda-like function process (x) that takes an argument x and returns its square. The main block checks if the current number ($1) is even ($1% 2==0). If it is, the script calls the ‘process’ function and prints the result. The script is run in a Unix-like environment (e.g., Linux, macOS) with the command bash script.sh. The output is the squares of the even numbers from the list. The script removes the numbers.txt file after processing to clean up.

In some embodiments, pseudocode 100 may comprise a first code sample for a first serverless application and/or other computing program. As described herein, a serverless application may be a type of software architecture where the backend infrastructure is managed by a cloud provider, allowing developers to focus solely on writing code without worrying about server management, scaling, or maintenance. In a serverless setup, the cloud provider automatically handles the allocation of resources, scaling, and operation of the application components, often through services like AWS Lambda, Azure Functions, or Google Cloud Functions. These services execute code in response to specific events or triggers, such as HTTP requests, database changes, or message queues. This model offers several advantages, including reduced operational overhead, automatic scaling, and cost efficiency, as users only pay for the actual compute time consumed by their code. Serverless applications are particularly well-suited for microservices, event-driven architectures, and applications with variable or unpredictable workloads. By abstracting away the infrastructure concerns, serverless computing enables faster development cycles, increased flexibility, and the ability to deploy applications more rapidly and efficiently.

The system may use an artificial intelligence tool for software code development that estimates runtime processing efficiency of serverless applications as well as provide recommendations for more efficient code for the serverless applications. Adapting artificial intelligence models for this practical benefit faces several technical challenges because writing code involves a deep understanding of the problem domain, user requirements, and/or specific context in which the code will be used. Moreover, the code must be robust, handle edge cases, and/or be easy to debug, which requires a comprehensive understanding of potential pitfalls and how to address them. Finally, any model that is used needs to understand and implement algorithms, data structures, and/or control flows, ensuring that the generated code is efficient and correct. Because of these technical challenges, any model that is trained must be specific to the objective, style, and/or developers looking to use the model; however, developers may often switch organizations, borrow code for other applications, make project-specific alterations, etc. Thus, there is no corpus of data available upon which to train a model.

The systems and methods overcome the lack of training data by generating training data using a novel approach. For example, while counterintuitive, the systems and methods may limit the amount and type of data used to generate training data to the user's existing code (e.g., available at a given serverless computing service provided by cloud platforms).

For example, the system may use an artificial intelligence model that is trained to generate outputs of recommendations for alternative lambda functions in response to receiving inputs of code samples. When doing so, the system may retrieve a first code base of a first user from a first computing service provided by a cloud platform. As mentioned above, limiting training data is conventionally seen as detrimental as it leads to reduced accuracy, overfitting, and/or insufficient coverage of edge cases. However, limiting training data in this manner does ensure that the code is trained to the objective, style, and/or developers standards; thus, overcoming some of the technical challenges above.

To do so, the system first authenticates the user or the service trying to access the code base. This involves validating credentials such as usernames, passwords, API keys, or tokens to ensure they have permission to access the specified resources. The cloud platform employs security protocols like OAuth or SAML for robust security measures. Once authenticated, the system identifies and locates the specific code base associated with the user. This is generally facilitated by a resource identifier, such as a URL or a unique resource locator that points to the location of the code base within the cloud service's infrastructure. After locating the code base, the system initiates the retrieval process. This might involve interfacing with a specific application programming interface (API) provided by the cloud platform that supports actions like GET requests for downloading files or data. The API sends a request to the server where the code base is stored, which then processes the request. The server responds to the API request by preparing the code base for transfer. This might involve packaging the code into a suitable format (e.g., zip files) and then sending it over the internet. The data transfer is typically secured with encryption protocols like TLS to protect the data integrity and privacy during transmission. On the client side, the received data is processed. This could involve decompressing the received package and loading the code into a local environment or another cloud service for further use or development.

With respect to the novel technical problem of reduced accuracy, overfitting, and/or insufficient coverage of edge cases, the model is trained to provide recommendations for more efficient lambda functions as opposed to the generic code itself. For example, lambda functions are typically smaller and more concise than generic code. They usually consist of a single expression or a few lines of code, making them easier to analyze and understand. This simplicity reduces the complexity the model needs to handle during training. Additionally, lambda functions have a consistent and well-defined structure. They follow a specific syntax, which makes it easier for models to recognize patterns and learn from them. This uniformity contrasts with the broader variability found in generic code. Finally, lambda functions are designed to perform specific, often single-purpose tasks. They encapsulate simple operations or transformations, making it easier for models to learn these specific tasks. Generic code, on the other hand, can encompass a wide range of functionalities and complexities, making it harder for models to generalize.

Furthermore, as opposed to training data for specific syntax structures, errors, and/or redundancies, the system trains a model to recommend lambda functions that reduce runtime processing efficiencies. For example, reducing runtime processing efficiencies is a clear, quantifiable objective. It can be measured directly in terms of execution time or computational resources consumed. This provides a straightforward metric for evaluating the performance of the model's recommendations. In contrast, identifying and correcting specific syntax structures, errors, and redundancies involves more subjective and nuanced assessments (thus requiring more training data). Additionally, the feedback loop for runtime processing efficiencies is immediate and objective. After making a change, the system can directly measure the impact on performance. This clear feedback loop helps in efficiently training and refining the model. Addressing syntax issues, errors, and redundancies often requires understanding code semantics and the broader context, making the feedback loop less direct (thus also requiring more training data). Finally, performance optimizations often focus on specific, isolated sections of code. They require understanding how individual functions or operations contribute to overall runtime. In contrast, fixing syntax errors, removing redundancies, or addressing semantic issues often requires a deep understanding of the entire codebase, its dependencies, and its logic flow (thus once again requiring mode training data).

The system may then parse the first code base to determine a first set of lambda functions. For example, the system may perform lexical analysis, where the source code is broken down into tokens, which are the smallest units of meaning like keywords, operators, identifiers, and literals. This may be followed by syntactic analysis, where these tokens are analyzed according to the language's grammar rules to form a syntax tree or abstract syntax tree (AST). For example, the AST represents the hierarchical structure of the code, making it easier to identify constructs such as functions and expressions. Using the parser, the system traverses the AST to identify lambda functions, which are typically defined by specific keywords or syntax patterns unique to each programming language (e.g., lambda in Python, →in JavaScript, or Func in C#). During this traversal, the parser collects relevant information about each lambda function, including its parameters, body, and the scope within which it is defined. Additionally, the parser may perform semantic analysis to understand the context and relationships within the code, ensuring that the identified lambda functions are valid and correctly implemented. This step might involve type checking, scope resolution, and dependency analysis. Advanced tools might also use pattern matching and heuristic algorithms to enhance the accuracy of lambda function identification. Finally, the collected lambda functions are compiled into a structured format, such as a list or a database, which can be further analyzed or utilized for various purposes like optimization, refactoring, or documentation. This systematic parsing approach allows the tool to effectively extract lambda functions from a codebase, providing valuable insights into the functional components of the software.

The system may determine respective runtime processing efficiencies for the first set of lambda functions. In one example, the system may start by capturing the execution time for each lambda function, which is the primary indicator of efficiency. The system might record the start and end times of each function invocation to calculate its total runtime. Additionally, metrics like CPU utilization, memory usage, and I/O operations are often monitored to provide a comprehensive view of each function's resource consumption. To accurately assess the efficiencies, these metrics can be aggregated and analyzed over multiple runs to mitigate anomalies due to external factors such as network latency or resource contention. Advanced monitoring tools or built-in features of the cloud platform (if the lambda functions are hosted on such a platform) can be employed to automatically collect this data. The results are typically presented through dashboards that highlight not only average runtimes but also deviations and outliers, helping developers identify potential bottlenecks or inefficiencies. Comparative analysis can also be conducted if there are multiple sets of lambda functions performing similar tasks under varying conditions. This allows the system to determine the most efficient set by comparing their performance metrics directly. By continuously monitoring these efficiencies, the system can dynamically adjust resources or optimize the lambda functions to ensure optimal performance.

In another example, the system may perform one or more tracing operations on the first code base to determine respective runtime processing efficiencies for the first set of lambda functions. For example, to perform tracing operations on a first code base to determine respective runtime processing efficiencies for a set of lambda functions, the system may employ a detailed instrumentation process. This process involves inserting tracing code or utilizing existing tracing frameworks within the lambda functions. These tracers collect data on various runtime aspects such as start and end times, function call durations, resource usage (CPU, memory), and input/output operations (e.g., “runtime characteristics”). The instrumentation can be fine-grained, capturing detailed information about each function call and its execution path within the lambda functions. This allows the system to identify not only how long each function takes to execute but also how they interact with other components and services, such as databases and external APIs. Tracing data is collected in real-time and can be streamed to a monitoring service where it is aggregated and analyzed. The analysis of this data provides insights into the performance characteristics of each lambda function. It highlights areas where execution time is disproportionately high, pinpointing potential inefficiencies or bottlenecks. The system can also compare this runtime data against performance benchmarks or previous runs to track efficiency improvements or regressions. Advanced tracing tools may also support anomaly detection algorithms that automatically identify unusual patterns in the performance data, suggesting possible code optimizations or adjustments. By continuously tracing and analyzing these lambda functions, the system can ensure they are optimized for both performance and resource utilization, leading to a more efficient operation overall.

The system may then generate training data by labeling the first set of lambda functions with the respective runtime processing efficiencies. For example, the system may execute each lambda function in the set under various conditions and workloads to simulate different operational scenarios. During these executions, the system captures detailed metrics, such as execution time, CPU usage, memory usage, I/O operations, and/or other runtime characteristics. Once the performance data is collected, the system analyzes these metrics to calculate the runtime processing efficiency of each lambda function. Efficiency might be quantified through a composite score that incorporates multiple performance factors, or by simpler metrics such as average execution time or resource utilization compared to the expected outcomes. These quantified efficiencies serve as labels. The system then pairs these labels with the corresponding lambda function's characteristics, input parameters, and contextual data collected during execution. This pairing results in a dataset where each entry consists of the lambda function's operational parameters and its labeled efficiency. This dataset is used as training data in machine learning models, where the models learn to predict the processing efficiency of lambda functions based on their operational characteristics. This process not only aids in optimizing existing lambda functions but also helps in designing more efficient ones in the future by providing insights into what characteristics or conditions lead to better or worse performance.

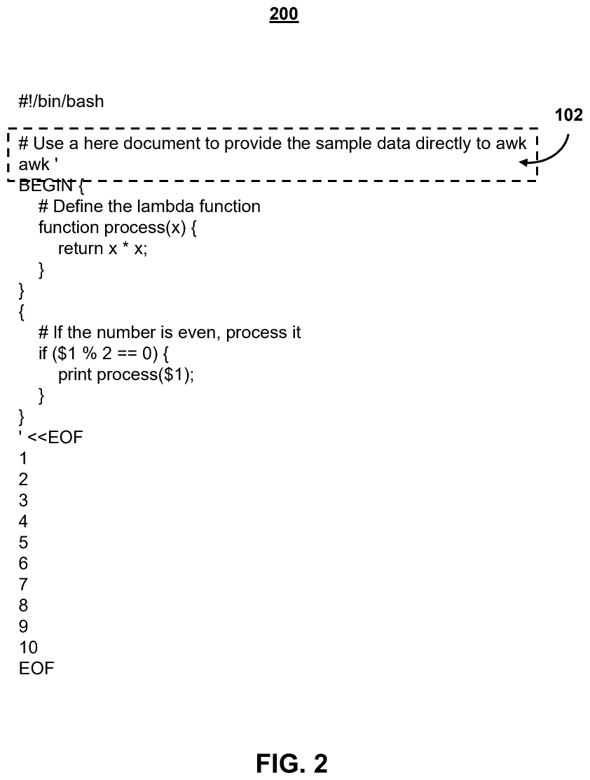

The system may train the first artificial intelligence model to generate outputs of recommendations for alternative lambda functions in response to receiving inputs of code samples. For example, FIG. 2 shows an illustrative diagram for recommended code featuring a revised lambda function with an improved runtime efficiency, in accordance with one or more embodiments. FIG. 2 includes pseudocode 200, which includes lambda function 202. In some embodiments, pseudocode 200 and/or lambda function 202 may be generated for display on a user interface.

As referred to herein, a “user interface” may comprise a human-computer interaction and communication in a device, and may include display screens, keyboards, a mouse, and the appearance of a desktop. For example, a user interface may comprise a way a user interacts with an application or a website. As referred to herein, “content” should be understood to mean an electronically consumable user asset, such as Internet content (e.g., streaming content, downloadable content, Webcasts, etc.), video clips, audio, content information, pictures, rotating images, documents, playlists, websites, articles, books, electronic books, blogs, advertisements, chat sessions, social media content, applications, games, and/or any other media or multimedia and/or combination of the same. Content may be recorded, played, displayed, or accessed by user devices, but can also be part of a live performance. Furthermore, user generated content may include content created and/or consumed by a user. For example, user generated content may include content created by another, but consumed and/or published by the user.

As shown in FIG. 2, lambda function 102 (FIG. 1) has been replaced with lambda function 202. Lambda function 202 has a higher runtime efficiency than lambda function 102 (FIG. 1). For example, as shown in pseudocode 200, the system avoids creating and deleting a temporary file by using a here document. Additionally, the system streamlines the awk command to process the data directly without the need for intermediate steps. For example, the <<EOF syntax allows the system to provide the input data directly within the script, eliminating the need to create and delete a temporary file. This reduces I/O operations and enhances runtime efficiency. Notably, the output is the same as in pseudocode 100 (FIG. 1).

For example, the system may receive a first code sample for a first serverless application (e.g., pseudocode 100 (FIG. 1)). The system may then identify a first lambda function in the first code sample (e.g., lambda function 102 (FIG. 1)). The system may then generate a first feature input for the first artificial intelligence model based on the first code sample and the first lambda function.

For example, the system may parse the code sample, extracting both the lambda function and the surrounding context. This involves lexical analysis to break the code into tokens and syntactic analysis to form an abstract syntax tree (AST), capturing the structural and hierarchical relationships within the code. Once the lambda function and its context are extracted, the system proceeds to feature extraction, where relevant characteristics of the code are identified and quantified. These features can include syntactic elements such as the types and numbers of operators and operands, structural aspects like the depth of nested expressions, and semantic features such as variable names, types, and the scope of the lambda function. Additionally, the system might consider the broader context of the lambda function within the code sample, including preceding and succeeding lines of code, to capture interactions and dependencies. Next, these extracted features are encoded into a numerical format that the model can process. This often may involve techniques like one-hot encoding for categorical features (e.g., variable names or operator types) and embedding representations for more complex elements (e.g., code tokens or entire expressions). The system may also normalize numerical features to ensure they are on a comparable scale. The encoded features are then aggregated into a single feature vector, which serves as the input for the model. This vector represents the lambda function and its surrounding context in a structured, numerical form that the model can analyze. The feature vector might include additional metadata, such as the position of the lambda function within the code sample or any annotations provided by developers. Finally, the feature vector is fed into the model, which can be trained to perform various tasks such as code optimization, error detection, or functionality prediction. By systematically converting the code sample and lambda function into a rich, numerical representation, the system enables the model to learn from the code and make informed decisions based on its features.

The system may then generate for display, on a user interface, first recommendation comprising a second lambda function for replacing the first lambda function in the first code sample. In some embodiments, the system may generate a plurality of recommendations and/or the respective runtime efficiencies of each. The system may generate candidate lambda functions that could potentially replace the first lambda function. These candidates are generated by applying learned patterns and best practices, aiming to improve performance, readability, or maintainability. The model might generate multiple candidates, each optimized for different criteria such as runtime efficiency, code simplicity, or adherence to coding standards.

To refine these candidates, the system evaluates them against the original code sample, simulating their integration and assessing their impact on the overall code. This evaluation can involve static analysis techniques to check for syntax correctness, type compatibility, and potential side effects. It may also include performance profiling to estimate runtime improvements or resource usage reductions. After evaluating the candidates, the system ranks them based on predefined criteria, such as performance gains, code clarity, or compliance with project-specific guidelines. The top-ranked candidate lambda function is selected as the recommended replacement. Finally, the system may generate a recommendation report, detailing the proposed second lambda function and the rationale behind its selection. This report may include a comparison of the first and second lambda functions, highlighting improvements and explaining how the new lambda function better meets the desired criteria. The recommendation is then presented to the developer, who can review and integrate the suggested lambda function into the codebase.

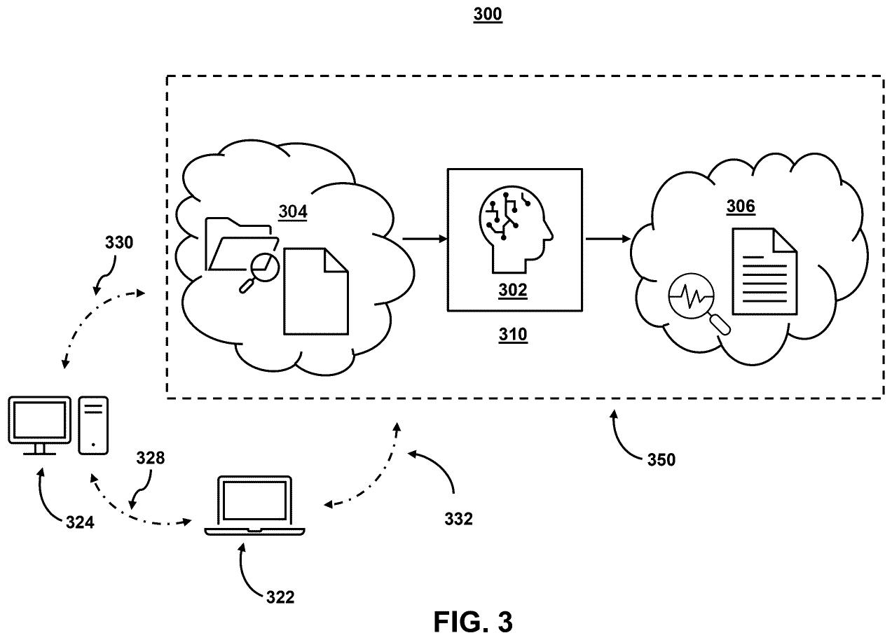

FIG. 3 shows illustrative components for a system used to estimate runtime processing efficiency of serverless applications and/or provide recommendations for more efficient code for the serverless applications, in accordance with one or more embodiments. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310. Cloud components 310 may alternatively be any computing device as described above, and may include any type of mobile terminal, fixed terminal, or other device. For example, cloud components 310 may be implemented as a cloud computing system, and may feature one or more component devices. It should also be noted that system 300 is not limited to three devices. Users may, for instance, utilize one or more devices to interact with one another, one or more servers, or other components of system 300. It should be noted, that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as touchscreen smartphones, these displays also act as user input interfaces. It should be noted that in some embodiments, the devices may have neither user input interfaces nor displays, and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include model 302, which may be a machine learning model, artificial intelligence model, etc. (which may be referred collectively as “models” herein). Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., a lambda function, runtime efficiency, and/or alternative lambda functions).

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, back propagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302 (e.g., a lambda function, runtime efficiency, and/or alternative lambda functions).

In some embodiments, the model (e.g., model 302) may automatically perform actions based on outputs 306. In some embodiments, the model (e.g., model 302) may not perform any actions. The output of the model (e.g., model 302) may be used to recommend a lambda function, runtime efficiency, and/or alternative lambda functions.

System 300 also includes API layer 350. API layer 350 may allow the system to generate summaries across different devices. In some embodiments, API layer 350 may be implemented on mobile device 322 or user terminal 324. Alternatively or additionally, API layer 350 may reside on one or more of cloud components 310. API layer 350 (which may be A REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web-services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: Front-End Layer and Back-End Layer where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open source API Platforms and their modules. API layer 350 may use a developer portal. API layer 350 may use strong security constraints applying WAF and DDOS protection, and API layer 350 may use RESTful APIs as standard for external integration.

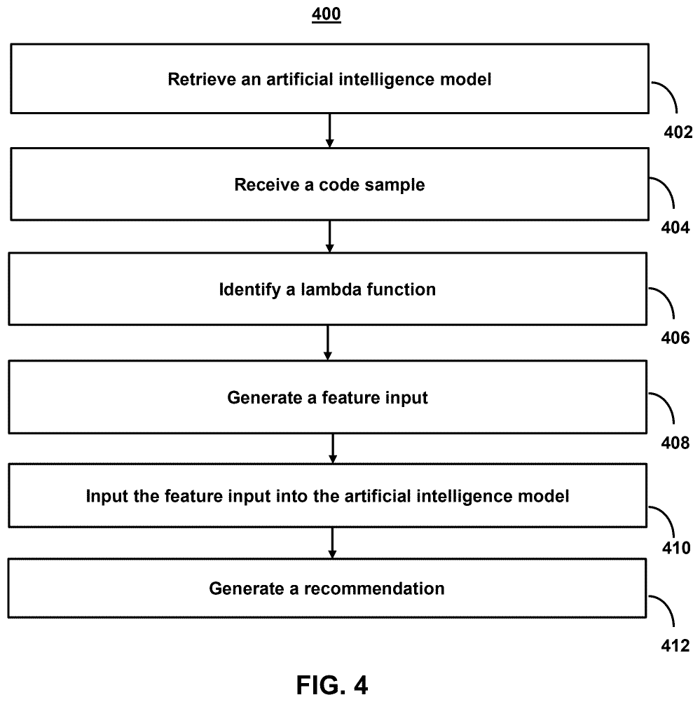

FIG. 4 shows a flowchart of the steps involved in providing recommendations for more efficient code, in accordance with one or more embodiments. For example, the system may use process 400 (e.g., as implemented on one or more system components described above) in order to provide an artificial intelligence tool for software code development that estimates runtime processing efficiency of serverless applications as well as provide recommendations for more efficient code for the serverless applications.

In some embodiments, the system may receive a first trigger for a code sample update. In response to detecting the first trigger during execution of the first code sample, the system may determine to update a code sample. For example, the system may be designed to monitor runtime environments for specific conditions that indicate the need for a code update. For example, during the execution of the first code sample, the system could be configured to log performance metrics and error rates continuously. If the system detects anomalies such as increased error rates, degraded performance, or resource overutilization, these conditions act as triggers. Such triggers prompt the system to consider updating or optimizing the code sample to address the detected issues. Another approach involves user-initiated triggers, where developers manually signal the need for a code update. This could be done through a user interface provided by the system, such as an integrated development environment (IDE) plugin or a web dashboard. Developers can flag certain parts of the code for review or optimization, thereby creating explicit triggers that the system recognizes and processes. Once a trigger is detected, the system initiates a sequence of actions to update the code sample. It might start by fetching the latest version of the code from the repository if the trigger was a code commit. If the trigger was a runtime condition, the system might first perform a detailed analysis of the execution logs to understand the issues before proceeding. For user-initiated triggers, the system could present the developer with options for code review or optimization based on the flagged sections. The system then proceeds to update the code sample by integrating new changes, applying optimizations, or suggesting improvements.

At step 402, process 400 (e.g., using one or more components described above) retrieves an artificial intelligence model. For example, the system may retrieve a first artificial intelligence model, wherein the first artificial intelligence model is trained to generate outputs of recommendations for alternative lambda functions in response to receiving inputs of code samples. For example, the system may train the first artificial intelligence model by retrieving a first code base of a first user, parsing the first code base to determine a first set of lambda functions, determining respective runtime processing efficiencies for the first set of lambda functions, and generating training data by labeling the first set of lambda functions with the respective runtime processing efficiencies.

In some embodiments, the system may determine the respective runtime processing efficiencies for the first set of lambda functions by performing a first tracing operation on the first set of lambda functions and receiving a first result of the first tracing operation. For example, once the lambda functions are identified, the system sets up a tracing operation to measure their runtime performance. This tracing operation involves instrumenting the code so that specific metrics can be collected during execution. Instrumentation may include inserting hooks or monitoring points in the code that record various performance metrics such as execution time, memory usage, CPU utilization, and I/O operations (e.g., a runtime characteristic). In some embodiments, the system may compare the first runtime characteristic to the second runtime characteristic. Based on comparing the first runtime characteristic to the second runtime characteristic, the system may select a lambda function for replacing another lambda function.

In some embodiments, determining the respective runtime processing efficiencies for the first set of lambda functions may comprise the system determining, during a first run, a first respective execution time for each lambda function in the first set of lambda functions. The system may then determine, during a second run, a second respective execution time for each lambda function in the first set of lambda functions. The system may aggregate the first respective execution time and the second respective execution time for each lambda function in the first set of lambda functions.

For example, the system begins by retrieving a code base from a user or a repository, which contains various lambda functions and other code constructs. The system then parses this code base, using lexical analysis to break the code into tokens and syntactic analysis to build an abstract syntax tree (AST), thereby locating lambda functions. Next, the system determines the runtime processing efficiencies of these lambda functions by running the code in a controlled environment and collecting metrics such as execution time, memory usage, and CPU utilization, often using profiling tools for accuracy. This data is then used to generate training data, where each lambda function is labeled with its respective runtime processing efficiencies. The labeled data forms the basis of the training dataset, which may also include additional contextual information about the lambda functions. Using this training dataset, the system trains a model by feeding the labeled data into a machine learning algorithm designed for code analysis and optimization, such as a neural network or decision tree model. The model learns to associate patterns in the code with their runtime efficiencies, enabling it to make informed recommendations for optimizing lambda functions.

Once trained, the model is stored in a model repository, a managed environment where models are versioned, indexed, and stored securely, ensuring they can be easily retrieved and deployed when needed. To retrieve the model for generating recommendations, the system connects to the model repository, querying it to locate the specific model trained for recommending alternative lambda functions. This query may include metadata such as the model name, version, training date, and specific use case. Once located, the model is retrieved from the repository and loaded into memory, involving deserialization of the model's parameters and structure for inference.

With the model loaded, the system can process new code samples to generate recommendations. It receives new code samples, including lambda functions that need optimization, and parses them to extract features. These features are encoded into a format that the AI model can process. The feature vectors are then fed into the model, which analyzes them and generates recommendations for alternative lambda functions. The model predicts which lambda functions are likely to improve runtime processing efficiencies based on the patterns it learned during training. Finally, the system presents the recommended lambda functions to the user, along with explanations or metrics that justify the suggestions, allowing the user to review and integrate these recommendations into their code base. This comprehensive process enables the system to effectively train, store, retrieve, and utilize a model to provide optimized lambda function recommendations, enhancing code performance and efficiency.

At step 404, process 400 (e.g., using one or more components described above) receives a code sample. For example, the system may receive a first code sample for a first serverless application. In the context of a first serverless application, the system might integrate with a version control system (VCS) such as Git. Developers typically commit and push their code to a VCS repository. The system can be configured to automatically trigger a process to fetch the latest code whenever a new commit is made, ensuring it always works with the most recent code sample. This integration can be facilitated by webhooks or other event-driven mechanisms provided by the VCS. Alternatively, the system might provide a web interface or an API endpoint where developers can manually upload their code samples. In this case, developers log into a dashboard, select the relevant project, and upload the code files or paste the code snippets directly into a text editor provided by the interface. This method is particularly useful for one-off analyses or when working with smaller code segments. In a continuous integration/continuous deployment (CI/CD) pipeline, the system can be integrated as a step within the pipeline. As code changes are pushed and the pipeline runs, the system automatically receives the code sample as part of the build process. This ensures that the code sample analyzed is always in sync with the latest development efforts.

At step 406, process 400 (e.g., using one or more components described above) identifies a lambda function. For example, the system may identify a first lambda function in the first code sample. The system takes the first code sample as input and begins the process with lexical analysis, where the source code is broken down into tokens. These tokens are the smallest units of meaning, such as keywords, operators, identifiers, and literals.

Following lexical analysis, the system performs syntactic analysis to build an Abstract Syntax Tree (AST). The AST represents the hierarchical structure of the code, highlighting how different tokens relate to each other within the code's grammar. The AST makes it easier to identify specific constructs in the code, such as functions, loops, and conditional statements. To identify lambda functions, the system may search the AST for patterns and keywords specific to lambda functions, which vary by programming language. For instance, in Python, lambda functions are defined using the lambda keyword, followed by a list of parameters, a colon, and an expression. In JavaScript, lambda functions (also known as arrow functions) are identified by the =>operator. The system looks for these syntactic markers to pinpoint the presence of lambda functions. Once a potential lambda function is located, the system examines its structure to confirm it adheres to the language's rules for lambda expressions. This involves checking for the correct number of parameters, ensuring the presence of an expression body, and validating the scope in which the lambda function operates. The system also considers the context of the lambda function, analyzing surrounding code to understand its role and how it interacts with other code elements.

In some embodiments, the system may also perform semantic analysis to ensure the identified lambda function is semantically valid. This involves type checking, resolving variable names to their declarations, and ensuring that the lambda function's usage aligns with the overall logic of the code. After identifying and validating the lambda function, the system can extract it and any relevant metadata, such as its parameters, return type, and the context in which it is used. This information is then used for further analysis, such as optimization, refactoring, or generating recommendations for alternative lambda functions.

At step 408, process 400 (e.g., using one or more components described above) generates a feature input. For example, the system may generate a first feature input for the first artificial intelligence model based on the first code sample and the first lambda function. For example, the system may perform feature extraction, where it identifies relevant characteristics of the lambda function and the overall code sample. These features may include syntactic elements like the types and counts of operators, operands, and control structures within the lambda function. Structural aspects, such as the depth of nested expressions and the overall complexity of the lambda function, are also considered. Additionally, the system analyzes semantic features, such as variable names, data types, and the scope in which the lambda function operates, to understand its functionality and usage better. After identifying these features, the system encodes them into a numerical format suitable for machine learning. Categorical features, like variable names and operator types, might be one-hot encoded, while more complex elements, like entire expressions or code tokens, could be represented using embedding techniques. Numerical features, such as the count of specific elements or the depth of nested structures, are normalized to ensure they are on a comparable scale. The encoded features are then aggregated into a single feature vector, representing the lambda function and its context within the code sample. This feature vector includes all relevant information in a structured format, making it suitable for input into the model. The feature vector may also include additional metadata, such as the position of the lambda function within the code sample or any annotations provided by developers.

At step 410, process 400 (e.g., using one or more components described above) inputs the feature input into the artificial intelligence model. For example, the system may input the first feature input into the first artificial intelligence model to generate a first output. For example, the system feeds this feature vector into the model, which has been trained to analyze such inputs and generate useful outputs, such as optimization recommendations, error detections, or functionality predictions.

At step 412, process 400 (e.g., using one or more components described above) generates a recommendation. For example, the system may, based on the first output, generate for display, on a user interface, first recommendation comprising a second lambda function for replacing the first lambda function in the first code sample. For example, the system may leverage a trained artificial intelligence model to analyze the feature vector derived from the first lambda function and its surrounding code context. The model, which has learned patterns from a vast dataset of lambda functions and their performance characteristics, generates a set of candidate lambda functions that could potentially replace the first one. These candidates are typically optimized for specific criteria, such as runtime efficiency, code simplicity, or error reduction. Once the model generates these candidate lambda functions, the system evaluates them against the original code sample to ensure compatibility and effectiveness. This evaluation involves static analysis to check for syntax correctness, type compatibility, and potential side effects. The system may also simulate the execution of these candidates to estimate performance improvements, ensuring that the recommended lambda function indeed enhances the runtime processing efficiency or other targeted metrics. After identifying the most suitable candidate, the system prepares a detailed recommendation for display on the user interface. This recommendation includes the second lambda function along with a comparison to the first lambda function. The comparison highlights key improvements, such as reduced execution time, lower memory usage, or simplified code structure. The recommendation also includes explanatory notes or metrics that justify why the second lambda function is a better choice, providing the user with a clear understanding of the benefits.

To present this recommendation, the system may use a user-friendly interface, typically a web or integrated development environment (IDE) plugin. The interface may display the original code sample with the first lambda function highlighted, alongside the suggested replacement lambda function. Interactive elements may allow users to view side-by-side comparisons, delve into performance metrics, and understand the rationale behind the recommendation. Additionally, the interface might offer one-click functionality to apply the suggested changes directly to the codebase, streamlining the workflow for the user. For example, the system may receive a user input accepting the first recommendation. The system may generate a second code sample replacing the first lambda function with the second lambda function.

In some embodiments, the system may generate for display the first recommendation by retrieving an approved lambda function list and validating the second lambda function based on the approved lambda function list. For example, the system may retrieve this approved lambda function list from a secure storage location, such as a database or a configuration file maintained by the development team or organization. This list contains lambda functions that have been previously vetted for performance, correctness, and best practices adherence. Once the system has access to the approved lambda function list, it proceeds to validate the second lambda function generated by the artificial intelligence model or suggested through another optimization process. This validation process involves comparing the second lambda function against the entries in the approved list to ensure it meets the required standards. The system checks various attributes of the lambda function, including its syntax, structure, and intended functionality, to find a match or ensure compatibility with the approved functions.

If the second lambda function matches one on the approved list or is deemed equivalent in terms of performance and reliability, the system confirms its validity. This step may involve additional checks, such as ensuring the lambda function adheres to coding standards, passes all relevant tests, and does not introduce new dependencies or security vulnerabilities. With the second lambda function validated, the system prepares a detailed recommendation for display on the user interface. This recommendation includes the second lambda function itself, along with contextual information explaining why it was chosen. The system may highlight the advantages of the second lambda function over the first, such as improved runtime efficiency, reduced memory usage, or enhanced readability and maintainability.

The recommendation is formatted to be user-friendly and informative. The user interface displays the original code sample with the first lambda function highlighted, alongside the recommended second lambda function. Comparative metrics and explanatory notes are included to help the user understand the benefits of making the switch. The interface might also feature interactive elements, allowing users to explore the differences in detail, view performance metrics, and understand the underlying reasoning for the recommendation.

By retrieving an approved lambda function list and validating the second lambda function against it, the system ensures that the recommendations provided to users are not only optimized but also adhere to established standards and best practices. This thorough validation and informative presentation help developers make confident, informed decisions about code improvements.

In some embodiments, the system may further use recommendations (and/or determinations related to recommendations) to update the training data. For example, the system may determine a first runtime efficiency for the first lambda function, label first lambda function with the first runtime efficiency, and update the training data with first lambda function. When the system makes a recommendation, such as suggesting a replacement lambda function to improve runtime efficiency, it collects detailed performance metrics and other relevant data points during and after the implementation of these recommendations. For example, after determining the first runtime efficiency for the first lambda function, the system labels this lambda function with its measured runtime efficiency. This labeling provides a clear and quantifiable performance metric that can be used for future training.

The system starts by executing the first lambda function in a controlled environment to gather accurate runtime performance metrics, including execution time, memory usage, and CPU utilization. These metrics represent the first runtime efficiency. The system then labels the first lambda function with this runtime efficiency, creating a comprehensive data point that links the lambda function's code with its performance characteristics.

Next, the system integrates this labeled data into its existing training dataset. This involves appending the new data point, which includes the lambda function's code, its labeled runtime efficiency, and any other contextual information, to the dataset used for training the artificial intelligence (AI) model. The contextual information may include details such as the size of the input data, the environment configuration, and any specific conditions under which the lambda function was executed.

As the system continuously receives new data from its recommendations and their outcomes, it periodically retrains the AI model using the updated dataset. This retraining process allows the model to learn from the latest examples, improving its ability to make accurate and effective recommendations in the future. By incorporating real-world performance data and continuously refining the training dataset, the AI model becomes more adept at understanding the nuances of code performance and optimization.

The updated training data enhances the model's predictive capabilities by providing a broader and more diverse set of examples. Each new labeled lambda function contributes to the model's understanding of how different coding patterns and structures impact runtime efficiency. This continuous learning loop ensures that the model evolves alongside the changing codebase and development practices, maintaining its relevance and accuracy.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method for software code development that estimates runtime processing efficiency of serverless applications to provide recommendations for more efficient code for the serverless applications.
2. The method of the preceding embodiment, further comprising: retrieving a first artificial intelligence model, wherein the first artificial intelligence model is trained to generate outputs of recommendations for alternative lambda functions in response to receiving inputs of code samples by: retrieving a first code base of a first user; parsing the first code base to determine a first set of lambda functions; determining respective runtime processing efficiencies for the first set of lambda functions; generating training data by labeling the first set of lambda functions with the respective runtime processing efficiencies; receiving a first code sample for a first serverless application; identifying a first lambda function in the first code sample; generating a first feature input for the first artificial intelligence model based on the first code sample and the first lambda function; inputting the first feature input into the first artificial intelligence model to generate a first output; and based on the first output, generating for display, on a user interface, first recommendation comprising a second lambda function for replacing the first lambda function in the first code sample.
3. The method of any one of the preceding embodiments, further comprising: receiving a user input accepting the first recommendation; and generating a second code sample replacing the first lambda function with the second lambda function.
4. The method of any one of the preceding embodiments, wherein determining respective runtime processing efficiencies for the first set of lambda functions further comprises: performing a first tracing operation on the first set of lambda functions; and receiving a first result of the first tracing operation.
5. The method of any one of the preceding embodiments, wherein retrieving the first code base of the first user further comprises: accessing a first computing service provided by a cloud platform; and providing first credentials for validating access to the first code base.
6. The method of any one of the preceding embodiments, wherein parsing the first code base to determine the first set of lambda functions further comprises: generating a tokenized code base based on the first code base; and processing the tokenized code base to generate an abstract syntax tree.
7. The method of any one of the preceding embodiments, wherein determining the respective runtime processing efficiencies for the first set of lambda functions further comprises: determining, during a first run, a first respective execution time for each lambda function in the first set of lambda functions; determining, during a second run, a second respective execution time for each lambda function in the first set of lambda functions; and aggregating the first respective execution time and the second respective execution time for each lambda function in the first set of lambda functions.
8. The method of any one of the preceding embodiments, wherein determining the respective runtime processing efficiencies for the first set of lambda functions further comprises: performing one or more tracing operations on the first code base; and determining a runtime characteristic of each lambda function of the first set of lambda functions based on the one or more tracing operations.
9. The method of any one of the preceding embodiments, wherein generating for display the first recommendation further comprises: determining a second runtime efficiency for the second lambda function; and generating for display the second runtime efficiency in the first recommendation.
10. The method of any one of the preceding embodiments, wherein generating for display the first recommendation further comprises: determining a second runtime efficiency for the second lambda function; and generating for display the second runtime efficiency in the first recommendation.
11. The method of any one of the preceding embodiments, wherein generating for display the first recommendation further comprises: determining a first runtime efficiency for the first lambda function; determining a second runtime efficiency for the second lambda function; comparing the first runtime efficiency to the second runtime efficiency; and based on comparing the first runtime efficiency to the second runtime efficiency, selecting the second lambda function for replacing the first lambda function in the first code sample.
12. The method of any one of the preceding embodiments, wherein generating for display the first recommendation further comprises: determining a preceding line of code in the first code sample; determining an interaction between the preceding line of code and the first lambda function; and validating the second lambda function based on the interaction.
13. The method of any one of the preceding embodiments, wherein generating for display the first recommendation further comprises: determining a first syntax in the first lambda function; and validating the second lambda function based on the second lambda function comprising the first syntax.
14. The method of any one of the preceding embodiments, wherein generating for display the first recommendation further comprises: retrieving an approved lambda function list; and validating the second lambda function based on the approved lambda function list.
15. The method of any one of the preceding embodiments, wherein retrieving the first artificial intelligence model further comprises: receiving a first trigger for a code sample update; detecting the first trigger during execution of the first code sample; and determining to retrieve the first artificial intelligence model based on detecting the first trigger.
16. The method of any one of the preceding embodiments, further comprising: determining a first runtime efficiency for the first lambda function; labeling first lambda function with the first runtime efficiency; and updating the training data with first lambda function.
17. One or more non-transitory, computer-readable mediums storing instructions that, when executed by a data processing apparatus, cause the data processing apparatus to perform operations comprising those of any of embodiments 1-16.
18. A system comprising one or more processors; and memory storing instructions that, when executed by the processors, cause the processors to effectuate operations comprising those of any of embodiments 1-16.
19. A system comprising means for performing any of embodiments 1-16.

What is claimed is:

1. A system for software code development that estimates runtime processing efficiency of serverless applications to provide recommendations for more efficient code for the serverless applications, the system comprising:
one or more processors; and
one or more non-transitory, computer-readable mediums, comprising instructions that, when executed by one or more processors, cause operations comprising:
retrieving a first code base of a first user from a first computing service provided by a cloud platform;
parsing the first code base to determine a first set of lambda functions in the first code base;
performing one or more tracing operations on the first code base to determine respective runtime processing efficiencies for the first set of lambda functions;
generating training data by labeling the first set of lambda functions with the respective runtime processing efficiencies;
training, using the training data, a first artificial intelligence model to generate outputs of recommendations for alternative lambda functions in response to receiving inputs of code samples;
receiving a first code sample for a first serverless application;
identifying a first lambda function in the first code sample;
generating a first feature input for the first artificial intelligence model based on the first code sample and the first lambda function;
inputting the first feature input into the first artificial intelligence model to generate a first output; and
generating for display, on a user interface, first recommendation comprising a second lambda function for replacing the first lambda function in the first code sample.

2. A method for software code development that estimates runtime processing efficiency of serverless applications to provide recommendations for more efficient code for the serverless applications, the method comprising:
retrieving a first artificial intelligence model, wherein the first artificial intelligence model is trained to generate outputs of recommendations for alternative lambda functions in response to receiving inputs of code samples by:
retrieving a first code base of a first user;
parsing the first code base to determine a first set of lambda functions;
determining respective runtime processing efficiencies for the first set of lambda functions; and
generating training data by labeling the first set of lambda functions with the respective runtime processing efficiencies;
receiving a first code sample;
identifying a first lambda function in the first code sample;
generating a first feature input for the first artificial intelligence model based on the first code sample and the first lambda function;
inputting the first feature input into the first artificial intelligence model to generate a first output; and
based on the first output, generating for display, on a user interface, first recommendation comprising a second lambda function for replacing the first lambda function in the first code sample.

3. The method of claim 2, further comprising:
receiving a user input accepting the first recommendation; and
generating a second code sample replacing the first lambda function with the second lambda function.

4. The method of claim 2, wherein determining the respective runtime processing efficiencies for the first set of lambda functions further comprises:
performing a first tracing operation on the first set of lambda functions; and
receiving a first result of the first tracing operation.

5. The method of claim 2, wherein retrieving the first code base of the first user further comprises:
accessing a first computing service provided by a cloud platform; and
providing first credentials for validating access to the first code base.

6. The method of claim 2, wherein parsing the first code base to determine the first set of lambda functions further comprises:
generating a tokenized code base based on the first code base; and
processing the tokenized code base to generate an abstract syntax tree.

7. The method of claim 2, wherein determining the respective runtime processing efficiencies for the first set of lambda functions further comprises:
determining, during a first run, a first respective execution time for each lambda function in the first set of lambda functions;
determining, during a second run, a second respective execution time for each lambda function in the first set of lambda functions; and
aggregating the first respective execution time and the second respective execution time for each lambda function in the first set of lambda functions.

8. The method of claim 2, wherein determining the respective runtime processing efficiencies for the first set of lambda functions further comprises:
performing one or more tracing operations on the first code base; and
determining a runtime characteristic of each lambda function of the first set of lambda functions based on the one or more tracing operations.

9. The method of claim 2, wherein generating for display the first recommendation further comprises:
determining a second runtime efficiency for the second lambda function; and
generating for display the second runtime efficiency in the first recommendation.

10. The method of claim 2, wherein generating for display the first recommendation further comprises:
determining a second runtime efficiency for the second lambda function; and
generating for display the second runtime efficiency in the first recommendation.

11. The method of claim 2, wherein generating for display the first recommendation further comprises:
determining a first runtime efficiency for the first lambda function;
determining a second runtime efficiency for the second lambda function;
comparing the first runtime efficiency to the second runtime efficiency; and
based on comparing the first runtime efficiency to the second runtime efficiency, selecting the second lambda function for replacing the first lambda function in the first code sample.

12. The method of claim 2, wherein generating for display the first recommendation further comprises:
determining a preceding line of code in the first code sample;
determining an interaction between the preceding line of code and the first lambda function; and
validating the second lambda function based on the interaction.

13. The method of claim 2, wherein generating for display the first recommendation further comprises:
determining a first syntax in the first lambda function; and
validating the second lambda function based on the second lambda function comprising the first syntax.

14. The method of claim 2, wherein generating for display the first recommendation further comprises:
retrieving an approved lambda function list; and
validating the second lambda function based on the approved lambda function list.

15. The method of claim 2, wherein retrieving the first artificial intelligence model further comprises:
receiving a first trigger for a code sample update;
detecting the first trigger during execution of the first code sample; and
determining to retrieve the first artificial intelligence model based on detecting the first trigger.

16. The method of claim 2, further comprising:
determining a first runtime efficiency for the first lambda function;
labeling the first lambda function with the first runtime efficiency; and
updating the training data with the first lambda function.

17. One or more non-transitory, computer-readable mediums, comprising instructions that, when executed by one or more processors, cause operations comprising:
retrieving a first artificial intelligence model, wherein the first artificial intelligence model is trained to generate outputs of recommendations for alternative lambda functions in response to receiving inputs of code samples by:
retrieving a first code base of a first user;
parsing the first code base to determine a first set of lambda functions;
determining respective runtime processing efficiencies for the first set of lambda functions; and
generating training data by labeling the first set of lambda functions with the respective runtime processing efficiencies;
receiving a first code sample;
identifying a first lambda function in the first code sample;
inputting the first code sample and the first lambda function into the first artificial intelligence model to generate a first output; and
based on the first output, generating for display, on a user interface, first recommendation comprising a second lambda function for replacing the first lambda function in the first code sample.

18. The one or more non-transitory, computer-readable mediums of claim 17, further comprising:
receiving a user input accepting the first recommendation; and
generating a second code sample replacing the first lambda function with the second lambda function.

19. The one or more non-transitory, computer-readable mediums of claim 17, wherein determining respective runtime processing efficiencies for the first set of lambda functions further comprises:
performing a first tracing operation on the first set of lambda functions; and
receiving a first result of the first tracing operation.

20. The one or more non-transitory, computer-readable mediums of claim 17, wherein retrieving the first code base of the first user further comprises:
accessing a first computing service provided by a cloud platform; and
providing first credentials for validating access to the first code base.
